(19) United States
(12) Patent Application Publication
(10) Pub. No.: US 2025/0347008 A1
(43) Pub. Date: Nov. 13, 2025

(54) ELECTROLYSIS PLANT, METHOD FOR OPERATING AN ELECTROLYSIS PLANT, AND COMBINATION COMPRISING AN ELECTROLYSIS PLANT AND A WIND TURBINE

(71) Applicant: Siemens Energy Global GmbH & Co. KG, München (DE)

(72) Inventor: Sven Schumann, Wilhermsdorf (DE)

(21) Appl. No.: 18/866,638

(22) PCT Filed: Jan. 20, 2023
(86) PCT No.: PCT/EP2023/051413

§ 371 Date: Nov. 18, 2024

(30) Foreign Application Priority Data
May 18, 2022 (DE) 10 2022 204 924.1

(51) Int. Cl. C25B 9/70; C25B 1/04; C25B 9/65; C25B 15/02

(52) U.S. Cl. CPC C25B 9/70; C25B 1/04; C25B 9/65; C25B 15/02

(57) ABSTRACT

An electrolysis plant includes at least one electrolysis module. The electrolysis module has a plurality of series-connected electrolysis cells. A DC-capable switching device is connected electrically in parallel and has an activatable power resistor such that, in the closed state, a current path through the power resistor can be activated so as to bypass electrolysis cells and to be able to drain excess power through the power resistor. There is also described a method for operating such an electrolysis plant for separating water into hydrogen and oxygen, and to a combination with an electrolysis plant that is connected directly to a wind turbine.

The invention relates to an electrolysis plant comprising at least one electrolysis module. The invention furthermore relates to a method for operating an electrolysis plant for breaking down water into hydrogen and oxygen and to a plant network having an electrolysis plant and a wind turbine connected to the electrolysis plant.

An electrolysis plant is an apparatus which uses electrical current to bring about material conversion (electrolysis). In accordance with the variety of different electrochemical electrolysis processes, there are also a large number of electrolysis plants, such as, for example, an electrolysis plant for water electrolysis.

Nowadays, hydrogen is produced from water by means of proton exchange membrane (PEM) electrolysis or alkaline electrolysis, for example. The electrolysis plants use electrical energy to produce hydrogen and oxygen from the supplied water. This process is performed in an electrolysis stack made up of a plurality of electrolysis cells. In this case, a plurality of electrolysis cells are connected in series to form an electrolysis module, or module for short. A plurality of modules are in turn interconnected in a series connection to form an electrolysis stack. In the electrolysis stack under a direct voltage (DC voltage), water is introduced as a starting material, wherein, once the water has flown through the electrolysis cells, two fluid streams occur as electrolysis products, consisting of water and gas bubbles (O₂ or H₂).

Present considerations are aimed at using excess energy from renewable energy sources at times with lots of sun and lots of wind, that is to say with above-average solar or wind power generation, to produce valuable materials. A valuable material may in particular be hydrogen produced by water electrolysis plants. Using hydrogen as a basis, it is possible, for example, to produce so-called renewable energy gas, also referred to as RE gas. An RE gas is a combustible gas obtained from renewable sources by using electrical energy.

In this case, hydrogen constitutes a particularly environmentally friendly and sustainable energy source. It has the unique potential to realize energy systems, transportation and large parts of the chemistry without CO₂ emissions. To make this possible, however, the hydrogen must not originate from fossil sources but rather has to be produced using renewable energies. In the meanwhile, at least a growing proportion of the power produced from renewable sources is fed into the public electricity grid. In accordance with the electricity mix, a corresponding proportion of green hydrogen can thus be produced if an electrolysis plant is operated with power from the public grid.

In electrolysis processes performed on the industrial scale, the DC current is provided predominantly by line-commutated rectifiers.

EP 3 556 905 A1 discloses a switching arrangement of this type for supplying DC current to a plurality of electrolyzers arranged in parallel. The switching arrangement comprises a rectifier which converts an AC voltage on the input side into a first DC voltage on the outside side. In this case, each electrolyzer is in each case connected via a rectifier converting the first DC voltage into a second DC voltage, in particular a step-down converter, in parallel with the output of the rectifier in such a way that the second DC voltage is dropped across the electrolyzer. Each of the rectifiers, in particular each of the step-down converters, is implemented in a controllable or adjustable manner so that it can be adapted in line with the amplitude of its second DC voltage, its output voltage. Using the step-down converter implemented in a controllable and/or adjustable manner for each of the electrolyzers thus allows the current flow through each electrolyzer to be adapted as required even when the electrolyzers are connected in parallel.

One source of renewable energies results from the increasing use of wind power. In particular with so-called off-shore wind turbines close to the coast, great electrical powers can be achieved. Having to bridge a large distance to the consumers is challenging, however. The energy should thus be transported to the consumer with as little loss as possible. Hydrogen is very suitable as a transport medium and energy source. This can be transported, for example, through pipelines in gaseous form. A positive secondary aspect in this case is that a hydrogen-carrying pipeline can fulfill the function of an energy store at the same time since the internal pressure can be varied within certain limits.

Based on these considerations, for example, it is of particular economic interest to produce the hydrogen directly at the location of the energy generation, that is to say autonomously and independently of the public grid. To this end, it is proposed to install the electrolysis plants on offshore platforms in the maritime sector directly on off-shore wind turbines or in the immediate vicinity thereof and to supply them with the electrical power generated.

Also for the mainland, such concepts of using the power from onshore wind turbines or photovoltaic plants at least partially for immediate hydrogen production by directly linking to and feeding into an electrolysis plant have also been proposed. In all of these applications, the electrolysis plant is part of an island network. The electrolysis current is thus not drawn from the public grid but rather is delivered directly from a wind turbine or a PV plant and fed into an electrolyzer of the electrolysis plant. In contrast to the line-commutated operation described above, in particular the direct connection in each case poses particular challenges and problems with regard to electrically linking and connecting the electrolysis plant to the respective RE generation plant to one another, be it a wind turbine or a photovoltaic plant, in particular in order to ensure reliable and especially disruption-free operation of the electrolysis plant in an immediate plant network comprising the RE generation plant.

There is therefore a great need for technical solutions and provisions for planned or unplanned operating situations of an electrolysis plant, in which, for example, a changed load has to be reacted to in a short time. This need can occur owing to changes in the generator power when connecting to an RE generation plant with regard to the provided power which is naturally subject to fluctuations. However, in particular also sudden changes in the availability of the output power on the part of an electrolysis plant can occur, for instance when one or more electrolysis modules, or an electrolysis stack comprising a plurality of series-connected modules, fails/fail.

The object of the invention is therefore to specify an electrolysis plant by means of which in particular power from a renewable source is able to be directly fed into the electrolysis plant, wherein high operational flexibility is provided while maintaining plant reliability. Further objects consist in specifying a corresponding method for operating an electrolysis plant and in specifying a plant network having an electrolysis plant and having a renewable energy plant.

The first-mentioned object is achieved according to the invention by an electrolysis plant comprising at least one electrolysis module, wherein an electrolysis module has a plurality of series-connected electrolysis cells, and comprising a DC-capable switching apparatus which is electrically connected in parallel and has a connectable power resistor such that, in the closed state, a current path through the power resistor is able to be activated with the result that electrolysis cells are bypassed and excess power is able to be dissipated through the power resistor.

The invention is already based on the knowledge that in electrolysis plants the electrolysis cells of an electrolysis module are very susceptible to being loaded with impermissibly high current densities. An overload can lead to breakdown of the electrolysis cells and to failure, moreover to locally induced short-circuits due to thermal overload owing to the locally high current densities inside the electrolysis cell and the components thereof. In the worstcase scenario, this can lead to loss of an entire electrolysis module which is generally made up of a multiplicity of axially stacked electrolysis cells which are electrically contact-connected in a series connection. Due to this series connection, an impermissible current flow therefore covers a multiplicity of electrolysis cells and electrolysis modules equally. Provisions for the operational reliability and plant reliability of an electrolysis plant which prevent overload and breakdown therefore need to be provided. This may be the case, for instance, when the input power or nominal power during normal operation of the electrolysis plant is no longer available due to an unforeseen sudden-temporary or permanent-failure of electrolysis cells or of an electrolysis module. A sudden loss or instantaneous reduction in input power would-without protective measures for consistent feeding-in of the DC current supplied to the electrolysis plant-endanger the entire plant and expose the electrolysis cells to an overload. The electrolysis modules are loaded here in particular, which electrolysis modules are still in parallel operation. Here, the current density would increase until the converters have been accordingly readjusted since the excess power which was previously applied to the now shutdown electrolysis has to be dissipated. In this case, the invention makes it possible for the excess power both on the generator side and on the load side to be dissipated through the power resistor as required, which is very advantageous for the protection of the plant.

By way of the DC-capable switching apparatus electrically connected in parallel with the electrolysis cells or with the electrolysis module, the invention provides a reliable technical solution directly at the electrolysis plant itself. This can advantageously reduce the reaction time for required connection of the power resistor by activating the current path. With this autonomous solution, it is furthermore advantageous that for the protective function no influence has to be initially exerted on the external source which continues to supply the nominal current. Initially, at least for a certain time, a control intervention by the power controller of the power source is thus not required. For instance, the controller can thus be configured in a simpler manner at the location since-not simultaneously with the limiting of the one converter-the converters connected in parallel already likewise have to be preventatively derated. This is particularly advantageous in particular in the case of a direct connection to a slow power generator, such as, for instance, a wind turbine. In wind turbines, namely tracking, in particular a necessary reduction and adaptation of the fed-in power in line with the input power, is only possible relatively slowly, i.e. the power controller on the generator side can only follow a new reduced setpoint value quite slowly. In contrast, bypassing individual or a plurality of electrolysis cells or else an entire electrolysis module as required is able to be effected and brought about instantaneously. The electrolysis plant can continue to remain in operation in this situation and, e.g., produce hydrogen, wherein the excess energy is able to be reliably dissipated via the power resistor of the switching apparatus. In island network operation, this also prevents an increase in voltage on the side of the external power source. This danger would exist if the power could not be consumed or removed anywhere else.

Furthermore, the invention provides a particularly reliable protective circuit for an overload, for instance when an electrolysis module or a plurality of electrolysis modules fails/fail, in order to reliably ensure overload protection of the electrolysis cells and of the electrolysis modules. Depending on the overload situation, the then excessively available power cannot be distributed to the electrolysis cells or electrolysis modules which are still in operation. In the case of failure or shut-down of individual or a plurality of electrolysis cells or of an electrolysis module, the fed-in power could no longer be removed by the electrolysis plant without sustaining damage. If these components or electrical subsystems of an electrolysis plant are shut down, the excess energy has to be absorbed. The power resistor, which can also be referred to as a braking resistor, is used for this purpose. When the current path is activated, the power resistor takes up the electrical energy completely and converts it into ohmic heat. This thermal energy is able to be further used for energy purposes as required as useful heat by coupling, for instance, to a heat reservoir or to a heat exchanger. The power resistor used can preferably, for instance, be an electromechanical high-power variable resistor for power applications. The resistor elements thereof are usually made of thick resistor wire which is suitable for conducting the nominal current over a relatively long period of time and for bypassing the electrolysis cells, provided that its ohmic resistance is minimal. However, also possible is a power resistor which only has to take over and dissipate the full current of the electrolysis for a few seconds. This time should be enough to be able to readjust the external power source for the power supplied to the electrolysis.

This problem is particularly pronounced in the case of a direct connection of an electrolysis plant to a DC source which is provided, for instance, by a photovoltaic plant or a wind turbine. The electrolysis plant is thus particularly advantageously set up for a direct connection and a direct feeding-in of DC current from a renewable energy plant. A very advantageous protective provision for planned or unplanned operating situations of the electrolysis plant, in which, for example, a changed load has to be reacted to in a short time, is thus achieved. This requirement can occur owing to changes in the generator power when connecting to an RE generation plant with regard to the provided power which is naturally subject to fluctuations in the generation. In an advantageous manner, however, particularly sudden changes in the availability of the output power on the part of an electrolysis plant can be met, such as in the case of an unforeseen failure of one or more electrolysis cells, of one or more electrolysis modules or of an electrolysis stack having a plurality of series-connected electrolysis modules. Generation peaks on the part of the generator power, e.g. of an RE plant, can thus also be at least partially absorbed.

In the case of a direct connection of the electrolysis plant to a wind turbine for supplying with 100% green power, a disadvantageous feedback or impact on the wind turbine, in particular the generator thereof, is also prevented by the switching apparatus having the power resistor in the case of bypassing. The systemic slowness on the generator side is thus decoupled. The electrolysis plant is thus designed such that it allows on the generator side—for instance in the case of a direct connection to a wind turbine—tracking and adaptation via power adjustment in accordance with the imminent control times.

In one particularly preferred configuration, the electrolysis plant comprises at least two series-connected electrolysis modules which each have a plurality of series-connected electrolysis cells.

The plant concept having the protective circuit by way of the integrated DC-capable switching apparatus is therefore able to be extended in modular fashion. A plurality of electrolysis modules can thus be advantageously combined to form an electrolysis plant, wherein an in particular modular application of the connectable power resistor is possible as required. As a result, electrolysis plants with great power are possible on the industrial scale. These are designed and equipped particularly for a temporarily occurring overload on the generator side. Particularly high operational flexibility is achieved while maintaining plant reliability.

Preferably, the parallel-connected switching apparatus in the closed state causes an electrolysis module to be bypassed. In the case of a usually modular structure of an electrolysis stack or of an electrolyzer comprising a plurality of series-connected electrolysis modules, it is greatly advantageous if the switching apparatus is set up for bypassing a respective electrolysis module. Thus, when required, the latter can be adapted in modular fashion and bypassed and a respective current path via the power resistor is able to be activated.

In this case, in an electrolysis plant, the switching apparatus in the closed state preferably causes a plurality of electrolysis modules to be bypassed. The electrolysis plant is thus advantageously set up such that a plurality of respective current paths for bypassing a plurality of respective electrolysis modules are able to be activated. The power resistor or the respective power resistors in a bypass current path are dimensioned in accordance with the power loss to be expected in the current path in the event of failure or shut-down. In the case of an electrolysis stack or of an electrolyzer comprising five series-connected electrolysis modules, for instance, the failure of one electrolysis module thus leads to 20% less output power on the electrolysis side. Accordingly, in the case of a module being bypassed, the power resistor has to be designed for the nominal power of an electrolysis module or, in the case of an only temporary loading, also considerably below the nominal power. The power resistor is designed such that it can be overloaded for a short time and is therefore especially also able to be used for plants with short peak currents. In the case of an electrolyzer, the individual electrolysis cells are typically stacked in an axial direction to form an electrolysis module comprising a multiplicity of individual electrolysis cells and installed to form the module or electrolysis module. In this case, an electrolyzer as a functional unit of an electrolysis plant usually has a plurality of electrolysis modules which together form a so-called electrolysis stack or simply “stack”. For example, 50 electrolysis cells can thus be axially stacked to form a module and 5 modules can in turn be stacked in the axial direction to form a stack so that an electrolysis stack of this kind can thus comprise, for example, 250 cells in an axial overall assembly. An electrolysis plant can have a plurality of parallel-connected electrolysis stacks or electrolyzers.

In one particularly preferred configuration of the electrolysis plant, the switching apparatus has a mechanically closable switching element. In this case, the switching element in particular is configured as an electrically or electromagnetically actuable switch or contactor.

In this case, it is also possible for a combination made up of a plurality of switching elements, in particular a combination of two switching elements, to be provided in a switching apparatus, wherein the switching elements are preferably designed for temporally staggered switching.

In the combination, a first switching element connects to the current path through the power resistor. A second switching element disconnects the main supply line for the provision of electrolysis current for the electrolysis plant.

The power resistor in this case is dimensioned in terms of its resistance value in such a way that it corresponds approximately to the resistance in the path of the electrolysis which it shuts down. Advantageously, no short-circuit thus takes place and the current would otherwise not commutate into the parallel path with the power resistor or at most divide up equally approximately 50:50.

This can be realized in an advantageous and cost-effective configuration also with only one switching element configured analogously to a toggle switch and having two current-carrying switching states, which switching element energizes the electrolysis in one position and, in the case of a bypass, loads the power resistor in the second position. This toggle-switch solution is preferably used if, e.g., a faulty electrolysis module is intended to be disconnected and as far as possible no switching operations are intended to take place at the parallel units.

Alternatively, also only one respective switching element could be worked with, as described above. This is then preferably designed and able to be activated such that, e.g., the faulty electrolysis that is to be bypassed is subjected to a hard shut-down and these load resistors are then connected in for the remaining parallel units for a certain period of time in order to absorb or collect the current peak on the generator side.

Advantageously, the configuration of the switching element as a contactor or else switching contactor is provided. This is an electrically or electromagnetically actuated switch for large electrical powers and is similar to a relay. The contactor knows two switching positions and switches monostably without particular provisions during normal operation. For the connection of the required high powers in a very short time via the power resistor, an electromechanical implementation is particularly advantageous. In this case, a magnetic coil is provided in the switching element.

When a control current flows through the magnetic coil of the electromechanical contactor, the magnetic field pulls the mechanical contacts into the active state. In the absence of current, a spring re-establishes the resting state; all contacts return to their starting position. The connections for control current for the magnetic coil and the contacts for auxiliary circuits (if present) and currents that are to be switched are implemented insulated from one another in the contactor: there is no conductive connection between control and switching contacts. In principle, a contactor is a relay having a significantly higher switching power. Typical loads begin at approximately 500 watts up to several hundred kilowatts up to several thousand kilowatts. The parallel connection of a plurality of switching elements or switching contactors accordingly allows higher powers to be able to be switched in, which, depending on the application case, is able to be flexibly adapted in line with the power that is to be dissipated via the power resistor. Accordingly, it is also possible to provide a plurality of power resistors having a corresponding power input which are connected in parallel.

In one particularly preferred configuration of the electrolysis plant, the switching apparatus has a thyristor as switching element such that when the thyristor is triggered the current path through the power resistor is able to be activated.

A thyristor is able to be used particularly advantageously as a switching element for high powers. The thyristor is a semiconductor component which is made up of four or more semiconductor layers of alternating doping. Thyristors are components which are able to be switched on, that is to say they are non-conducive in the starting state and can be switched on by a small current at the gate electrode. After being switched on, the thyristor also remains conductive without gate current. It is switched off when a minimum current, the so-called holding current, is undershot. By injecting current into the third layer (actuation at the gate), the thyristor can be triggered, i.e. be switched into a conductive state. As a result, the current path through the power resistor is closed, i.e. activated.

A prerequisite therefor is a positive voltage between the anode and cathode as well as a minimum current through the middle barrier layer. The thyristor is turned off, that is to say put into the blocking state, either when the holding current is undershot, which generally happens when the voltage in the load circuit shuts off or reverses polarity or at the current zero crossing of the load circuit (e.g. in the rectifier), or by reversing the polarity into the blocking direction. The speed of this procedure is limited by the so-called circuit-commutated recovery time which is required for the thyristor to obtain its full control and blocking capabilities again following the end of the current conduction phase.

It is also possible for a thyristor and an electromagnetically actuable switch to be present as switching element in the switching apparatus. Depending on the configuration of the electrolysis plant, application and specific load situation in the current path that is to be switched, combinations are possible.

Alternatively, in the switching apparatus the switching element is preferably configured as a semiconductor component which has an insulated-gate bipolar transistor (IGBT) such that when the gate of the IGBT is opened the current path through the power resistor is able to be activated.

An IGBT is a component that is readily used in power electronics since it combines the advantages of the bipolar transistor, such as good on-state behavior, high reverse voltage, robustness, and the advantages of a field-effect transistor having virtually power-free actuation. The prominent advantages of IGBTs are the high voltage and current limits at operating voltages of up to 6500 V and currents of up to 3600 A for a power of up to 100 MW. As a result, the IGBT is ideally able to be used in the rectifier 15 for the operating range of the electrolyzer 3. Depending on the application, the use of a so-called IGCT, i.e. an integrated gate-commutated thyristor, is also conceivable. The latter has a reduced circuitry complexity, an increase in the maximum pulse frequency for actuation as well as better switching times in series connection, which is advantageous. The field of application of IGCTs are high-power converters. In this case, a single module typically switches a few kiloamperes at a typical reverse voltage of 4500 V.

In one preferred configuration, the power resistor is variable or adjustable. In this case, the implementation as an adjustable high-load resistor is to be provided for example with a high nominal current of 10 to 30 amperes, in particular of 15.0-20.0 amperes, and a nominal power of 1.5 to 10.0 kilowatts, typically 2.0 kilowatts. In order to conceive of higher powers and higher nominal currents in the case of the bypassing, parallel connections comprising a plurality of power resistors are flexibly provided as required to form an entire power resistor in the respective current path. Depending on the technology of the electrolysis, the current that is to be practically dissipated is typically at a few kiloamperes in the case of an electrolysis plant, that is to say around a factor of 100 greater than possibly specified or available for an individual power resistor. Arrangements and circuits comprising a number of several power resistors are thus also encompassed. The power resistor can, as required and depending on the application case, also be implemented as a water bath or have a water bath. The current is then simply dissipated through a water bath as required.

More preferably, the power resistor is designed for an overload such that the power resistor, when it is energized for up to 5 seconds, in particular for up to 10 seconds, is able to be operated at a decaying current and excess power is able to be dissipated.

Since the load resistor controls the current when the braking resistors are bypassed, the braking resistors should, by definition, be designed for a continuous current, the nominal current. The load resistor can also be overloaded for a short time, however, and is therefore especially also able to be used for plants with short peak currents, such as for instance particularly advantageously in the electrolysis plant. In accordance with the load curve, for example for a braking energy of 2 kW which is to be turned off and which is pending for at most 4 seconds, a power resistor having a maximum continuous load of between 800-1000 watts can be used, which is approximately 200% to 250% of the nominal value of nominal current or nominal power. Advantageously, an overload-capable power resistor is therefore used, with as high a limit voltage of up to 5000 volts as possible and a high nominal current.

The overload capability of the power resistor is preferably 200% to 300%, in particular approximately 250%, at a decaying current of up to 5 seconds. This is a particularly interesting operating range in which, on the side of the power source, in particular in the case of a wind turbine, corresponding power control is able to be carried out within the same time of approximately 5 seconds on the feed-in side and required tracking or reducing of the DC power that is able to be supplied to the electrolysis plant to a reduced value is performed. As a result, adaptation is very advantageously achieved, which in the case of a direct connection of the electrolysis plant to a wind turbine allows for high operational reliability.

In a particularly preferred configuration of the electrolysis plant, in the switching apparatus a further current path is provided in parallel with the current path through the connectable power resistor, which further current path has a further switching element as well as a diode in the forward direction and/or a low-impedance resistor in series with the further switching element, wherein the further current path in a closed state has a lower electrical resistance than the electrolysis cells such that when electrolysis cells are bypassed a polarity and a protective voltage for the electrolysis cells are maintained.

The further current path, which is able to be connected in parallel with the current path as required, very advantageously allows a further protection requirement to be recognized and realized in the switching apparatus. This protective circuit in the further current path is very advantageous and flexible especially for operating situations of electrolysis cells or of a plurality of electrolysis modules in part-load operation. In the case of insufficient availability and feeding-in of electrolysis power by an external power source, in particular electrolysis current, provision is thus made for setting up a further current path for the targeted and at the same time reliable bypassing of individual or of a plurality of electrolysis cells for reliable part-load operation and thus advantageous extension of the operating window of the electrolysis plant. By means of the switching apparatus configured in this way, the electrolysis plant is set up both for an overload danger when electrolysis cells fail or shut-down, that is to say also in an underload situation for example due to reduced generation, or for the case in which selected electrolysis cells or an electrolysis module are temporarily put out of operation, for instance for planned maintenance purposes. This kind of bypassing allows these components to be practically short-circuited. The energizable electrolysis cells or electrolysis modules can be operated substantially below nominal load, which is more efficient than running all of the electrolysis cells or electrolysis modules in part-load.

In this case, a protective circuit is proposed in the further current path, which protective circuit ensures a protective voltage as initial voltage having corresponding polarity of the bypassed electrolysis cells or selectively of an entire electrolysis module in the electrolysis plant. This protective circuit leads to a considerable improvement in the operational reliability in part-load operation since the protective initial voltage across the diode and/or across the low-impedance resistor very effectively counteracts the danger of damaging fuel cell operation in the case of the bypassed electrolysis modules. Without this protective provision, due to the remaining product gases, hydrogen and oxygen, in the cathode space or anode space of the bypassed electrolysis module on account of the electrochemical potentials, a very disadvantageous fuel cell process would begin, which is to be avoided. This danger is tackled in a targeted way by way of this advantageous development of the electrolysis plant. Moreover, by avoiding the undesired fuel cell operation—as the reverse process of the electrolysis operation—the service life of the involved components of an electrolysis cell is considerably increased. Operational management that is optimized in terms of service life is thus likewise possible.

In one preferred configuration, the electrolysis plant has a plurality of series-connected electrolysis cells such that an electrolysis module is formed, with the result that when the further current path is activated by closing the further switching element the electrolysis module is bypassed, wherein a polarity and a protective voltage for the electrolysis module are maintained.

Bypassing an entire electrolysis module via the current path and the connectable power resistor is thus provided for an overload situation, or alternatively the further current path is able to be activated by closing the further switching element such that improved and particularly economical part-load operation with effective protection of the short-circuited electrolysis module is achieved. When the further current path is activated for part-load operation, the current path having the power resistor is not energized but rather this current path is bypassed.

For this purpose, the resistance of the further current path is preferably selected such that the resulting division of current leads to the electrolysis module being sufficiently energized in the relevant current range in order to prevent undesired fuel cell operation.

In one particularly preferred configuration, the electrolysis plant has a connection unit with an input for connecting to an external DC source and an output which is connected to an electrolysis module, wherein the connection unit has a transformer to the primary side of which an inverter is connected and to the secondary side of which a rectifier is connected such that a DC current is able to be supplied to the electrolysis modules.

With this advantageous development of the electrolysis plant, the connection unit provides an AC intermediate circuit which provides electrical decoupling between an external DC source and the electrolysis plant. In the AC intermediate circuit, the inverter converts the DC voltage from the external DC source into an AC voltage which couples to the primary side of the transformer. A rectifier is connected to the secondary side of the transformer, which rectifier converts the AC voltage back into a DC voltage, namely to a predetermined voltage or current level desired for the electrolysis. The connection unit is therefore configured particularly advantageously as an AC intermediate circuit and designed for the provision of DC current by an external DC source for supplying electrolysis current to the electrolysis plant. This takes place by directly coupling or directly connecting the input to an external DC source. As the external DC source, a wind turbine or a photovoltaic plant is advantageously able to be connected to the electrolysis plant which in each case can be advantageously configured grid-independently in so-called island operation both for offshore and onshore applications.

In this case, the external DC source is able to be connected directly and immediately via the input of the connection unit such that a DC power supply to the electrolysis plant is achieved. By virtue of the electrical separation and decoupling via the AC intermediate circuit, with the connection unit a damaging inflow of stray currents is additionally reliably avoided and thus also ground fault currents and undesired voltage losses in the electrolysis plant. At the same time, a simple and reliable direct connection of the electrolysis plant to a renewable energy generation plant, in particular to a wind turbine, is able to be achieved and facilitates grid-independent operation.

In this case, in one preferred configuration, the rectifier can be designed to be adjustable and/or as a three-phase rectifier, in particular as a B6 bridge rectifier.

Adjustability of the one or more rectifiers which are advantageously designed as three-phase rectifiers or as B6 bridge rectifiers makes it possible to vary the overall current generated by the one or more rectifiers and thus to control, for example, the operation of an electrolyzer, or of a plurality of electrolyzers, connected to the connection unit.

Preferably, provision is made for the AC frequency to be able to be adjusted to a predetermined value in the connection unit. By virtue of the configuration of the switching arrangement as an AC intermediate circuit, the latter does not have to be connected to a public grid and the AC frequency in the transformer is thus chosen largely freely. Advantageously, a high-frequency transformer is provided here such that it is possible to stray from the usual frequencies in the public grids as required. The connection unit can thus for instance be designed for an AC frequency in a transformer configured as a high-frequency transformer of 500 Hz to 50 kHz, in particular of 10 kHz to 30 kHz. However, a corresponding design and application of the transformer for operation at grid frequency remain possible.

In one preferred configuration of the electrolysis plant, the connection unit is designed for an AC frequency which is greater than the usual grid frequencies of 50 Hz to 60 Hz in the public grids. It is advisable to use high frequencies here since the size and the weight of the transformer and the material use can be reduced as a result.

This aspect is very advantageous in particular in the case of a direct connection of the electrolysis plant to a wind turbine. By virtue of the more compact construction and the lower weight at a high operating frequency, the transformer can, for example, be accommodated in the nacelle of the wind turbine or in the base of the tower of the wind turbine. The switching arrangement as a whole can likewise be arranged there. The electrolysis plant can thus, for example, be in the immediate vicinity of the wind turbine so that short cable paths for the connection are possible.

In one particularly preferred configuration, the switching arrangement is designed for an AC frequency of 500 Hz to 50 kHz, in particular of 10 kHz to 30 kHz. This frequency relates to the frequency of the inverter and of the rectifier which are connected to the transformer. In order to take advantage of the installation space advantages and cost advantages, the transformer provided is a high-frequency intermediate-circuit transformer.

Preferably, the transformer has a transformation ratio of less than 10, in particular of between 1.5 and 7.5. It is possible to flexibly adapt this to meet the requirements of the electrolyzer or of the desired voltage level for the electrolysis process and so, depending on the application, larger transformation ratios are also possible.

The ratio of the number of turns, or rather of the voltages on the primary and secondary sides, is also referred to as transformation ratio. Through suitable selection of the transformation ratio, that is to say of the number of turns, the transformer can be used to both step up and step down AC voltages. As a result, adaptation with a view to the electrolysis is advantageously possible.

In this case, a voltage step of greater than 10 is also possible, depending on the application and design of the electrolysis plant and especially of the transformer used. Known electrolysis plants are typically operated at a DC voltage of at most 1500 V, which still corresponds to a low-voltage range. For connection to a power generation plant, certainly more than 15 kV DC voltage can be provided and be available, however. An upper limit for the voltage step of up to 70 can therefore also preferably be selected. The available connection voltage—for instance provided that the electrolysis plant would operate at only 1000 V DC voltage—can then be up to around 70 kV. In the case of the presently available wind turbines, output voltages of 66 kV AC voltage can occur, for example.

A further aspect of the invention relates to a method for operating an electrolysis plant with high operational flexibility while maintaining plant reliability.

The associated object is achieved according to the invention by a method for operating an electrolysis plant for breaking down water to form hydrogen and oxygen, in which an inventive electrolysis plant according to the invention is provided, in which, during normal operation, an electrolysis current is supplied to at least two electrolysis modules, wherein hydrogen and oxygen are produced in the electrolysis module, in which bypass operation is initiated if one of the electrolysis modules fails, wherein the current path through the power resistor is activated such that the failed electrolysis module is bypassed, and in which the excess power is taken up by the power resistor.

In particular in the case of an unforeseen failure or an emergency shut-down of one or more electrolysis modules, or of part of an electrolysis stack or of an electrolyzer comprising one or more electrolysis modules or even of the entire electrolysis plant, the method is used to immediately activate a protective procedure on the part of the electrolysis plant. In the case of said protective procedure, depending on the reduction in the power input, the failed electrolysis module or the plurality of failed electrolysis modules is/are put out of operation or deenergized by being instantly bypassed. As a result, the entire electrolysis plant is protected against overload. A generator-side external power controller on the side of an, e.g., mechanically slow power generator can normally not control, i.e. reduce, the power rating quickly enough in order to adapt it in line with a reduced input power of the electrolysis plant and to track it. One example of this is a wind turbine which, for example, for a power loss of 20% in the electrolyzer, requires a few seconds of time to accordingly adapt the angle of attack of the rotor blades. The power generated in excess during this time may-depending on a previous operating point-not be distributed to the electrolysis modules which are still running, in order not to generate any impermissibly high current densities there.

During bypass operation, in the method of the invention, the excess energy is therefore advantageously dissipated by virtue of the current path through the power resistor being activated in the electrolysis plant, in particular until the power generation plant has, if necessary, been adjusted to the new situation.

Preferably, in the method, the supplied electrical power is adapted in line with the reduced input power of the electrolysis plant, wherein the electrolysis current is reduced and a temporally decaying current strength across the power resistor is brought about.

In this case, the supplied electrical power is preferably fed in from a wind turbine to which the electrolysis plant is connected, wherein, during bypass operation, the angle of attack of the rotor blades is adapted in line with the input power of the electrolysis plant.

More preferably, the supplied electrolysis current is in this case adapted in line with the reduced input power of the electrolysis plant within a maximum of 10 seconds, in particular within a maximum of 5 seconds. In the case of a wind turbine, times of up to 5 seconds are typically particularly advantageous in order to adapt the power adaptation of the output power in line with the input power of the electrolysis plant and to conclude it. At the same time, during this time, a decaying high current strength is able to be routed through the overload-capable power resistor such that, during bypass operation, advantageous adaptation of the output power in line with the input power and at the same time effective overload protection of the electrolysis plant are achieved.

A further aspect of the invention relates to a plant network comprising an electrolysis plant which has high operational flexibility while maintaining operational reliability of the plant network.

The associated object is achieved according to the invention by a plant network comprising an electrolysis plant and a wind turbine, wherein an output for providing DC current is provided, wherein the output is connected to an input of the electrolysis plant.

In this case, the plant network according to the invention is to be functionally understood to mean that the AC voltage originally generated by the wind turbine at the generator undergoes rectification in each case, i.e. is rectified in a rectifier for use and connection to an electrolysis plant. Depending on the technical plant configuration of the plant network, the output of the rectifier for providing DC current can be physically arranged within the electrolysis plant, for example in a container of the electrolysis plant or a container or housing of an electrolyzer.

The wind turbine itself then preferably outputs only an AC voltage which is accordingly rectified for electrolysis purposes. The output for providing DC current can be formed by the wind turbine itself which has a rectifier or to which a rectifier is assigned. The rectifier can also be allocated to the electrolysis plant, however.

As a result, island network operation independent of the public grid is possible in the plant network as well as immediate use of power exclusively from a wind turbine for the electrolysis such that 100% green hydrogen can be formed.

More preferably in this case the wind turbine has a rectifier the DC side of which is connected to the input of the electrolysis plant or is electrically connected to the input. In this case, the rectifier converts the original AC current from a generator of the wind turbine into a DC current and at the same time advantageously provides the desired input DC voltage level for the connection to the electrolysis plant. In an alternative configuration, the electrolysis plant can also have the rectifier such that AC current is fed in from the wind turbine. The rectification in the application of an advantageous direct connection of a wind turbine to an electrolysis plant is to be understood functionally.

In an alternative configuration, it is preferably also possible for the renewable energy plant in the plant network to be a photovoltaic plant. A PV plant already makes a DC current available during operation. However, provision can then preferably be made for the photovoltaic plant in the plant network to have a DC controller or DC converter the output side of which is connected to the input of the electrolysis plant. Particularly preferably, the renewable energy plant in the plant network is a wind turbine.

Advantages and advantageous configurations of the electrolysis plant of the invention should be considered to be advantages and advantageous configurations of the method for operating an electrolysis plant and advantages and advantageous configurations of the plant network and vice versa.

Further advantages, features and details of the invention are apparent from the following description of preferred exemplary embodiments and on the basis of the drawing. The features and combinations of features mentioned above in the description, and the features and combinations of features mentioned below in the description of the FIGS. and/or shown in the individual figures themselves, cannot only be used in the respectively specified combination but also in other combinations or by themselves without departing from the scope of the invention.

Exemplary embodiments of the invention are explained more thoroughly on the basis of a drawing. In the drawing, in schematic and greatly simplified fashion:

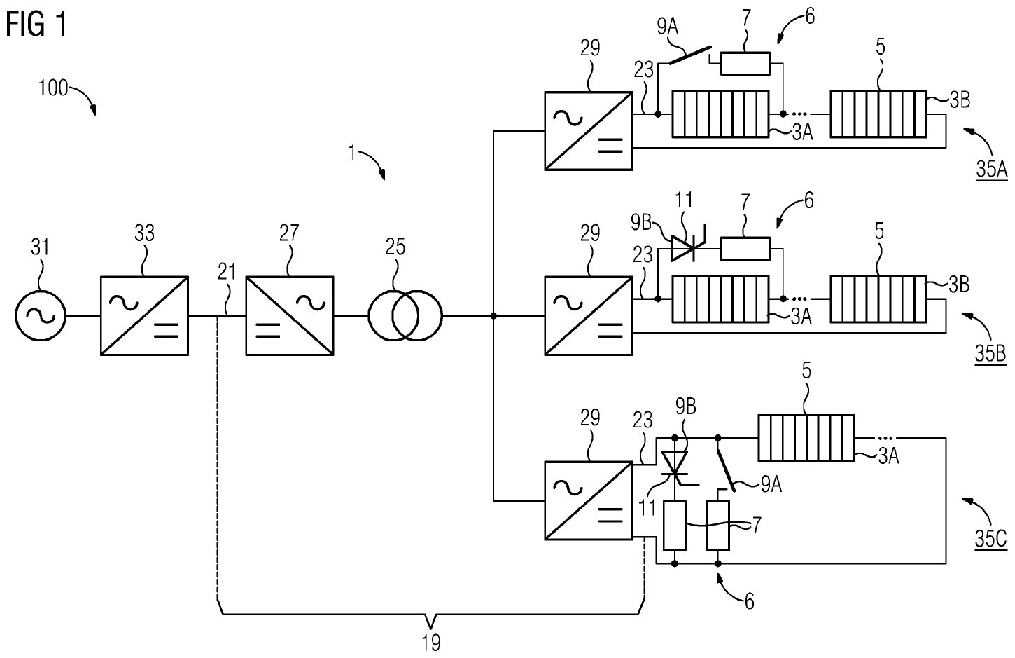

FIG. 1 shows a plant network with an electrolysis plant comprising a plurality of electrolyzers and with a wind turbine;

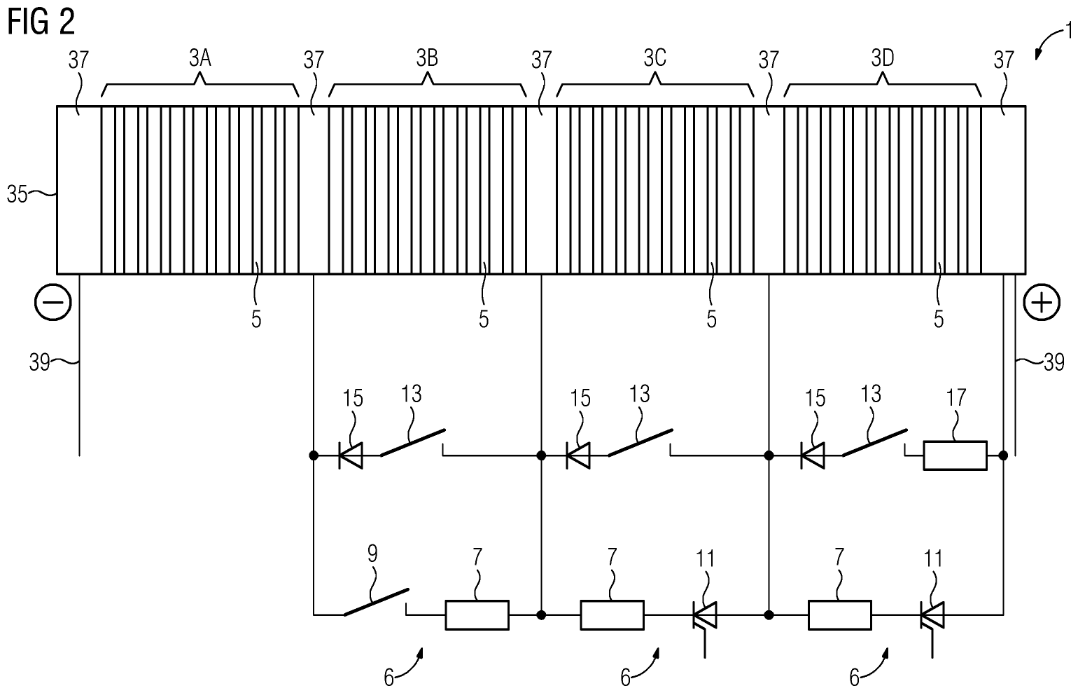

FIG. 2 shows a section of an electrolysis plant with an electrolyzer and a plurality of DC-capable switching apparatuses.

Identical reference signs in the figures have the same meaning.

FIG. 1 illustrates a plant network 100 according to the invention. The plant network 100 comprises an electrolysis plant 1 and a wind turbine 31 connected to the electrolysis plant 1 as a renewable energy plant (RE plant) and source of green power. The electrolysis plant 1 has three electrolyzers 35A, 35B, 35C connected in parallel and a connection unit 19 which is electrically connected to the electrolyzers 35A, 35B, 35C. The connection unit 19 is used to supply electrolysis current to the electrolyzers 35A, 35B, 35C.

The connection unit 19 is connected to the electrolyzers 35A, 35B, 35C via a respective output 23. Furthermore, the connection unit 19 has an input 21 via which a DC current is able to be supplied to the electrolysis plant 1, in particular to the electrolyzers 35A, 35B, 35C. The DC current is supplied from a DC source via the connection unit 19. For this purpose, the connection unit 19 has an inverter 27, a transformer 25 and a rectifier 29. In this case, a respective rectifier 29 is connected to the electrolyzers 35A, 35B, 35C such that a respective rectifier 29 supplies DC current for the electrolysis to one of the electrolyzers 35A, 35B, 35C in each case. The connection unit 19 is thus used in the electrolysis plant 1 to provide an AC intermediate circuit by way of which the input 21 is electrically decoupled from the output 23. The inverter 27 is connected to the primary side of the transformer 25. The rectifier 23 is connected to the secondary side of the transformer 25. The electrolyzer 35A, 35B, 35C is supplied with a DC current, the electrolysis current, via the rectifier 23 of the connection unit 19. In this case, the electrolyzers 35A, 35B, 35C can be configured as a PEM electrolyzer, as an AEM (anion exchange membrane) electrolyzer or as an alkaline electrolyzer.

In order to be supplied with a DC current for the electrolysis process, the electrolysis plant 1 is connected directly to the wind turbine 31. In this case, the connection takes place directly via the input 21 of the connection unit 19 which is accordingly designed to receive and transfer a DC current to the inverter 27. First of all, the wind turbine 31 generates an AC current in a generator of the wind turbine 31. In order to be able to deliver a DC current to the electrolysis plant 1, a rectifier 33 is provided such that the connection takes place via this rectifier 33, wherein the rectifier 33 is advantageously an electrical power component of the wind turbine 33.

In the exemplary embodiment shown, each of the electrolyzers 35A, 35B, 35C comprises a plurality of electrolysis modules 3A, 3B which are connected in series in each case. One or more electrolysis modules 3A, 3B can thus be connected one after another, for example, to form a respective electrolyzer 35A, 35B, 35C. Each of the electrolysis modules 3A, 3B has a plurality of, in particular a large number of, electrolysis cells 5 which are stacked in an axial direction and are both electrically contact-connected and fluidically connected to one another such that water starting material is able to be supplied and the product gas streams are able to be led out for further use. For example, fifty electrolysis cells 5 can be installed to form an electrolysis module 3A, 3B such that two hundred and fifty or more electrolysis cells 5 are installed in one electrolyzer 35A, 35B, 35C. An electrolyzer 35A, 35B, 35C set up in this way comprising a plurality of electrolysis modules 3A, 3B is also referred to as an electrolysis stack which can be interpreted as a functional unit in an electrolysis plant 1. In the configuration of an electrolyzer 35A as an alkaline electrolyzer, it is possible, owing to the large powers of alkaline electrolyzers, for also only one electrolysis module 3A to be provided.

The electrolysis module 3A comprises a DC-capable switching apparatus 6 which is electrically connected in parallel. The switching apparatus 6 has a connectable power resistor 7. As a result, in a closed state of the switching apparatus 6, a current path through the power resistor 7 is able to be activated, as a result of which a number of electrolysis cells 5 of the electrolysis module 3A are bypassed and excess power is able to be dissipated through the power resistor. In the present case, the electrolysis module 3A is able to be bypassed as well as accordingly all of the electrolysis cells 5 of the electrolysis module 3A. It is also possible for all of the electrolysis modules 3A, 3B in an electrolyzer 35A, 35B, 35C to be provided with the switching apparatus 6, or for the switching apparatus 6 to be configured in such a way that individual or a plurality of electrolysis cells 5 are able to be bypassed. Combinations are also possible such that bypass current paths can be closed individually and design-specifically for an electrolysis plant 1 on the level of the electrolysis cell 5, the electrolysis modules 3A, 3B or on the level of one of the electrolyzers 35A, 35B, 35C. In this case, various configurations are possible for the switching apparatus 6.

In the electrolyzer 35A, for example, the switching apparatus 6 has a mechanically closable switching element 9A which is implemented as an electromagnetically actuable switch with a short switching time in the range of only a few milliseconds, in particular of between 2 ms and 10 ms, for example 4 ms. In the electrolyzer 35A, the electrolysis module 3A is able to be bypassed completely when the switching element 9A is closed. In the electrolyzer 35B connected in parallel with the electrolyzer 35A, the switching apparatus 6 has a thyristor 11 as switching element 9B. The thyristor 11 is implemented as a power component for high switching currents and has short switching times of only a few milliseconds, in particular of approximately 3 ms, such that the electrolysis module 3B is able to be bypassed in a short time when the thyristor 11 is triggered. In the electrolyzer 35C, a connection is selected in the case of which the switching apparatus 6 bypasses all of the electrolysis modules 3A, 3B and thus the entire electrolyzer 35C. In this case, the two supply lines at the positive pole and at the negative pole are able to be bypassed via the switching apparatus 6 directly at the output 23 of the rectifier 29, that is to say are able to be closed to form a short-circuit as required. Only for the sake of illustration, FIG. 1 here shows, by way of example, both a configuration of the switching element 9B with a thyristor 11 and a power resistor 7, and a switching element 9A with an electromagnetically actuable switch or contactor. Both implementations are possible as an individual implementation or in a combination in the switching apparatus 6. In this case, provision can preferably be made for—not shown in more detail in FIG. 1—depending on the bypassing situation for a desired complete bypassing, the switching contact to be implemented in such a way that a first electrical contact goes to the electrolyzer 35C and a second electrical contact to the power resistor 7. The electrolyzer 35C can thus be completely bypassed.

The power resistor 7 is designed for an overload and is variable or adjustable in terms of its resistance value such that adaptation in line with the respective use situation is possible. The design for an overload is performed in such a way that the power resistor 7, when it is energized for up to five seconds, in particular for up to 10 seconds, is able to be operated at a decaying load current. Short-term operation via the nominal current is thus actually possible and a very large power is able to be dissipated via the power resistor 7 during bypassing.

During operation of the plant network 100, green power is generated in the wind turbine 31. The AC current generated in the generator is converted into a DC current in the rectifier 33. As a result, the wind turbine 31 provides a DC source such that, via the output of the rectifier 33, a DC current is fed directly into the input 21 of the electrolysis plant 1 and initially delivered to the connection unit 19. In the connection unit 19, electrical separation of the circuits is carried out by the transformer 25 such that possible ground faults and stray currents which damage the electrolysis cells 5 are also advantageously effectively suppressed or even avoided in the plant network 100. For the connection to the primary side of the transformer 25, conversion into an AC voltage initially takes place. The transformer 25 transforms this AC voltage such that a desired voltage level in accordance with the set transformation ratio is achieved on the secondary side. By way of the rectifier 29, a disturbance-free or hum-free electrolysis DC voltage is provided on the output side at the output 23, with which electrolysis DC voltage the electrolyzers 35A, 35B, 35C in the electrolysis plant 1 are stably operated, wherein water starting material is broken down into hydrogen and oxygen. Ground loops are effectively avoided by way of the electrical decoupling. By way of the advantageous direct DC connection of the electrolysis plant 1 to the wind turbine 31, grid-independent island operation is additionally possible as well as decentralized generation of green power onshore or offshore depending on the application. The proportion of generated green hydrogen is 100% in this case.

In principle, a DC connection of the electrolysis plant 1 to a photovoltaic plant or to another renewable energy plant, for example a so-called CSP (concentrated solar power) plant or to an energy store loaded by means of renewable energies is also possible in the plant network 100. However, the electrolysis plant 1 is, particularly owing to the DC-capable switching apparatus 6, advantageously set up and able to be operated reliably and flexibly for operation in a plant network 100 having a direct connection to a wind turbine 31. During operation of the electrolysis plant 1, water starting material is supplied to the electrolysis cells 5 via the electrolysis modules 3A, 3B and broken down into hydrogen and oxygen.

FIG. 2 shows a section of an electrolysis plant 1 having an electrolyzer 35 which has four electrolysis modules 3A, 3B, 3C, 3D and three DC-capable switching apparatuses 6. With respect to the switching apparatus 6 shown in FIG. 2, the switching apparatus 6 is further designed for flexible operation of the electrolysis plant 1, in particular for part-load operation of an electrolyzer 35 of the electrolysis plant 1.

Each of the electrolysis modules 3A, 3B, 3C, 3D comprises a multiplicity of axially stacked electrolysis cells 5. In this case, the electrolysis cells 5 are arranged between two pressure plates 37. The pressure plates 37 press the electrolysis cells 5, which in particular comprise a proton exchange membrane, closely and firmly together such that electrical contact between adjacent electrolysis cells 5 as well as a fluid-tight cell stack are brought about. The pressure plates 37 which are arranged at the axial end—that is to say at the edge—of the electrolyzer 35 are electrically connected to a DC source via an electrical connection 39. Three switching apparatuses 6 are arranged in parallel with the electrolysis modules 3B, 3C and 3D of the electrolyzer 35. In this case, the switching apparatuses 6 are arranged electrically in parallel with the electrolysis modules 5. In this example, corresponding switching apparatuses 6 allow a respective electrolysis module 3B, 3C, 3D to be electrically bypassed. In this case, each switching apparatus 6 is electrically connected to those pressure plates 37 which delimit the corresponding electrolysis module 3B, 3C, 3D.

In this exemplary embodiment, in the switching state shown, the electrolysis, in particular the breaking down of water to form hydrogen and oxygen, takes place in all of the electrolysis modules 3A, 3B, 3C, 3D of the electrolyzer 35 since all of the switching apparatuses 6 are open. The electrolysis is carried out with a DC current. The switching apparatuses 6 are each configured as DC-capable switching apparatuses 6 so that various current paths are available for a bypass.

In this case, compared to the exemplary embodiment of FIG. 1, in the electrolysis plant 1 of FIG. 2 in the switching apparatus 6 a further current path is set up in parallel with the current path through the connectable power resistor 7. This further current path has a further switching element 13 as well as a diode 15 in the forward direction and/or a low-impedance resistor 17 in series with the further switching element 13. The further current path in a closed state has a lower electrical resistance than the electrolysis cells 5 such that when electrolysis cells 5 are bypassed a polarity and a protective voltage for the electrolysis cells 5 are maintained. Various circuitry implementations and also combinations are possible for the further current path here. The electrolysis modules 3B and 3C, for instance, are thus able to be bypassed via a respective further current path, wherein via the further switching element 13 the current path can only be closed via the corresponding diode 13 in the forward direction. The electrolysis module 3D is able to be bypassed via a low-impedance resistor 17 when the further switching element 13 is closed, as a result of which the corresponding further current path is closed. In this case, the diode 15 is interconnected in the forward direction in a series connection with a further switching element 13. Advantageously, the polarity and a protective voltage for the electrolysis cells 5 or the electrolysis modules 3B, 3C, 3D are maintained when the further current path is closed. It is also possible to provide a combination of diode 13 and low-impedance resistor 17 in a further current path, a potentially advantageous circuit variant which is not shown specifically in FIG. 2.

The electrolysis plant 1 has a multiplicity of series-connected electrolysis cells 5 such that electrolysis modules 3A, 3B, 3C, 3D are formed. When the further current path is activated by closing the further switching element 13, the corresponding electrolysis module 3B, 3C, 3D is bypassed, wherein a polarity and a protective voltage for the bypassed electrolysis module 3B, 3C, 3D are maintained. This is particularly advantageous especially for part-load operation of the electrolysis plant 1 which is improved thereby. Individual or a plurality of electrolysis cells 5, one or more electrolysis modules 35, can thus be short-circuited as needed by means of the further current path provided by the switching apparatus 6 and therefore produce no hydrogen, i.e. are taken out of operation. This should only be done if damaging fuel cell operation is avoided—e.g. by using a pole rectifier which advantageously supplies power to each cell individually. In cooperation with the current path through the power resistor 7, provided in parallel in the switching apparatus 6, both overload operation, for instance in the case of a high wind power feed-in, and part-load operation of the electrolysis plant 1 with great operational flexibility and operational reliability are thus possible. A possibly required emergency shut-down of electrolysis modules or planned shut-down, e.g. for maintenance purposes, can also be carried out safely with temporary shut-down by way of the bypass operation.

The electrolysis plant 1 is operated under full load in the switching state of the switching apparatus 6 shown in FIG. 2. If the electrical power in the grid is now decreased, in particular due to less wind and less sun, at least one switching apparatus 6 can thus be closed. The electrolysis modules 3B, 3C and 3D can thus be switched off, or be bypassed via the further current path, in modular fashion. In the example of FIG. 2, the electrolysis module 3A is constantly operated during operation of the electrolysis plant 1. However, a bypass current path through a switching apparatus 6 connected to the electrolysis module 3A can also be provided. If, depending on the available electrical feed-in power during operation, individual electrolysis modules 3B, 3C, 3D are now switched off or bypassed, the electrolysis module 3A can thus continue to be operated at a constant power density, for instance under full load. Advantageously, none of the electrolysis modules 3A, 3B, 3C, 3D or of the electrolysis cells 5 is thus operated in part load. It is particularly advantageous to bypass the electrolysis modules 3B, 3C, 3D temporally successively. In particular, first of all module 3B can be bypassed for a predefined period of time. Electrolysis module 3C or electrolysis module 3D can then be bypassed for a corresponding period of time. The electrolysis modules 3B, 3C, 3D are thus operated and loaded equally. Bypassing via the further current path prevents the electrolysis cells 5 from aging quickly. Furthermore, it is ensured that the product gas quality, in particular of the hydrogen, remains constantly high. At the same time, however, the supplied electrical power can also be flexibly adapted in line with a reduced input power of the electrolysis plant 1 during operation, wherein the electrolysis current is reduced and a temporally decaying current strength across the power resistor 7 is brought about by virtue of a current path across the power resistor 7 then being selectively closed. The further, parallel current path across the low-impedance resistor 17 then remains open.

In the exemplary embodiment of FIG. 2, the electrolyzer 35 has four electrolysis modules 3A, 3B, 3C, 3D. This is a simplified illustration. It is likewise possible in the context of the invention for a larger number of electrolysis modules to be connected one after the other in series. It is likewise possible to arrange further staggered interconnections of the switching apparatuses 6 in order to, on the one hand, provide a sufficient number of switching apparatuses 6 and, on the other hand, prevent an excessive number of switching apparatuses 6 and therefore complexity. It is also very advantageously possible to integrate the electrolyzer 35 into a complex electrolysis plant 1 having a plurality of corresponding electrolyzers 35A, 35B, 35C, as already illustrated in more detail in FIG. 1. For this purpose, the electrical connection 39 in FIG. 2 is connected to the output 23 of the rectifier 29 of the electrolysis plant shown in FIG. 1 so that the electrolyzer 35 is supplied with DC current.

In a similar way to how it is presented in FIG. 1, integration into an entire plant network 100 comprising an electrolysis plant 1 and a wind turbine 31 connected directly to the electrolysis plant 1 is also very advantageously possible. For this purpose, the wind turbine 31 has an output for providing DC current, wherein the output is connected to an input 21 of the electrolysis plant 1. In the plant network 100, the wind turbine 31 has a rectifier 33 the DC side of which is connected to the input 21 of the electrolysis plant 1. It is alternatively also possible for the required rectification of an AC current originally generated by the wind turbine 31 in the generator to take place in the vicinity of the electrolysis itself. As a result, it is possible for the rectifier 33 to be able to be placed at the electrolysis plant 1 or immediately in the vicinity thereof. Consequently, the rectifier 33 having the output for DC current for the electrolysis can itself also be a plant component of the electrolysis plant 1 or be functionally considered to be such in the structural design of the plant network 100.

Although the invention has been illustrated and described more thoroughly in detail by way of preferred exemplary embodiments, the invention is not limited by the disclosed 11 examples. Variations thereof can be derived by a person skilled in the art without departing from the scope of protection of the invention as defined by the following patent claims.

18. 1-18 (canceled)

19 An electrolysis plant, comprising:
an electrolysis module having a plurality of series-connected electrolysis cells;
a DC-capable switching apparatus electrically connected in parallel and including a connectable power resistor;
wherein, in a closed state, a current path is established through said power resistor, for bypassing electrolysis cells and for dissipating excess power through said power resistor.

20. The electrolysis plant according to claim 19, comprising at least two series-connected electrolysis modules each having a plurality of series-connected electrolysis cells.

21. The electrolysis plant according to claim 20, wherein said parallel-connected switching apparatus, in the closed state, causes an electrolysis module to be bypassed.

22. The electrolysis plant according to claim 20, wherein said switching apparatus, in the closed state, causes a plurality of said electrolysis modules to be bypassed.

23. The electrolysis plant according to claim 19, wherein said switching apparatus has a mechanically closable switching element that is configured as an electrically or electromagnetically actuatable switch or contactor.

24. The electrolysis plant according to claim 19, wherein said switching apparatus comprises a thyristor forming a switching element, and wherein said thyristor is configured, upon being triggered, to activate the current path through said power resistor.

25. The electrolysis plant according to claim 19, wherein said switching apparatus has a switching element configured as a semiconductor component with an insulated-gate bipolar transistor (IGBT), and wherein opening the gate of said IGBT activates the current path through said power resistor.

26. The electrolysis plant according to claim 19, wherein said power resistor is a varistor or an adjustable resistor.

27. The electrolysis plant according to claim 19, wherein said power resistor is configured for an overload such that the power resistor, upon being energized for up to 5 seconds, is configured for operation at a decaying current and for dissipating excess power.

28. The electrolysis plant according to claim 27, wherein said power resistor, upon being energized for up to 10 seconds, is configured for operation at a decaying current and for dissipating excess power.

29. The electrolysis plant according to claim 19, wherein said switching apparatus is formed with a further current path in parallel with the current path through said connectable power resistor, said further current path having a further switching element and at least one of a diode in a forward direction or a low-impedance resistor in series with said further switching element, and wherein in a closed state said further current path has a lower electrical resistance than said electrolysis cells in order to maintain a polarity and a protective voltage for said electrolysis cells when said electrolysis cells are bypassed.

30. The electrolysis plant according to claim 29, comprising a plurality of series-connected electrolysis cells together forming an electrolysis module, wherein, when said further current path is activated by closing said further switching element, said electrolysis module is bypassed and a polarity and a protective voltage for said electrolysis module are maintained.

31. The electrolysis plant according to claim 19, further comprising:
a connection unit with an input for connecting to an external DC source and with an output connected to said electrolysis module;
said connection unit having a transformer, an inverter connected to a primary side of said transformer, and a rectifier connected to a secondary side of said transformer and configured to supply a DC current to said electrolysis modules.

32. A method for operating an electrolysis plant for breaking down water to form hydrogen and oxygen, the method comprising:
providing an electrolysis plant according to claim 19;
during normal operation, supplying an electrolysis current to at least two electrolysis modules of the electrolysis plant and producing hydrogen and oxygen in the electrolysis module;
initiating a bypass operation when one of the electrolysis modules fails, and activating a current path through the power resistor for bypassing the one electrolysis module and taking up excess power by the power resistor.

33. The method according to claim 32, which comprises adapting supplied electrical power to a reduced power uptake of the electrolysis plant, and thereby reducing the electrolysis current and bringing about a temporally decaying current strength across the power resistor.

34. The method according to claim 33, wherein the electrolysis plant is connected to a wind turbine and the supplied electrical power is fed in from the wind turbine, and the method comprises, during bypass operation, adapting an attack angle of rotor blades of the wind turbine to the input power of the electrolysis plant.

35. The method according to claim 32, which comprises adapting the supplied electrolysis current to the reduced input power of the electrolysis plant within a maximum time period of 10 seconds.

36. The method according to claim 35, which comprises adapting the supplied electrolysis current to the reduced input power of the electrolysis plant within a maximum time period of 5 seconds.

37. A plant network, comprising:
an electrolysis plant according to claim 19; and
a wind turbine, and an output for carrying DC current connected to an input of said electrolysis plant.

38. The plant network according to claim 37, wherein said wind turbine has a rectifier with a DC side connected to the input.
